(19) United States
(12) Patent Application Publication
(10) Pub. No.: US 2015/0286356 A1
(43) Pub. Date: Oct. 8, 2015

(54) METHOD, APPARATUS, AND TERMINAL DEVICE FOR CONTROLLING DISPLAY OF APPLICATION INTERFACE

(71) Applicant: Xiaomi Inc., Beijing (CN)

(72) Inventors: Daqing Sun, Beijing (CN); Cai Zhu, Beijing (CN); Weixing Li, Beijing (CN)

(73) Assignee: Xiaomi Inc.

(21) Appl. No.: 14/745,632

(22) Filed: Jun. 22, 2015

Related U.S. Application Data
(63) Continuation of application No. PCT/CN2013/090891, filed on Dec. 30, 2013.

(30) Foreign Application Priority Data
Jan. 31, 2013 (CN) 201310038609.3

(51) Int. Cl. G06F 3/0484; G06F 3/0488

(52) U.S. Cl. CPC G06F 3/0484; G06F 3/0488

(57) ABSTRACT

A method for controlling display of an application interface is provided. The method includes: detecting a first screen-touching operation; detecting a second screen-touching operation after detecting the first screen-touching operation; determining a movement direction and a movement distance of the second screen-touching operation; and causing the display of the application interface to be moved based on the movement direction and the movement distance of the second screen-touching operation.

### CROSS-REFERENCE TO RELATED APPLICATIONS

The present application is a continuation of international Application No. PCT/CN2013/090891, filed Dec. 30, 2013, which is based upon and claims priority to Chinese Patent Application No. 201310038609.3, filed Jan. 31, 2013, the entire contents of all of which are incorporated herein by reference.

### TECHNICAL FIELD

The present disclosure generally relates to the field of interface control and, more particularly, to a method, an apparatus, and a terminal device for controlling display of an application interface.

### BACKGROUND

With the development of mobile terminals, an increased number of mobile terminals are equipped with touch-screen displays. Users may enjoy various functions through screen-touching operations by moving their fingers on the touch-screen displays. Conventionally, an application interface is displayed on a page by page basis. When an application interface includes two or more pages for displaying on a touch-screen display, the user may perform a screen-touching operation on the touch-screen display to move the display of the application interface, so as to view contents of the application interface included in a different page. For example, in a home screen of a mobile operating system, when the user touches the touch-screen display and slides a finger straightly with a sliding distance exceeding a preset threshold, a next page to a current page of the home screen may be displayed. In this manner, contents on different pages of the home screen may be viewed.

### SUMMARY

According to a first aspect of the present disclosure, there is provided a method fir controlling display of an application interface, comprising: detecting a first screen-touching operation; detecting a second screen-touching operation after detecting the first screen-touching operation; determining a movement direction and a movement distance of the second screen-touching operation; and causing the display of the application interface to be moved based on the movement direction and the movement distance of the second screen-touching operation.

According to a second aspect of the present disclosure, there is provided a terminal device, comprising: a touch-screen display; a processor; and a memory for storing instructions executable by the processor. The processor is configured to: detect a first screen-touching operation; detect a second screen-touching operation after detecting the first screen-touching operation; determine a movement direction and a movement distance of the second screen-touching operation; and cause the display of the application interface to be moved based on the movement direction and the movement distance of the second screen-touching operation.

According to a third aspect of the present disclosure, there is provided a non-transitory computer-readable storage medium having stored therein instructions that, when executed by a processor of a terminal device, cause the terminal device to perform a method for controlling display of an application interface, the method comprising: detecting a first screen-touching operation; detecting a second screen-touching operation after detecting the first screen-touching operation; determining a movement direction and a movement distance of the second screen-touching operation; and causing the display of the application interface to be moved based on the movement direction and the movement distance of the second screen-touching operation.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for controlling display of an application interface, according to an exemplary embodiment.

FIG. 2 is a flowchart of a method for controlling display of an application interface, according to an exemplary embodiment.

FIG. 3 is a schematic diagram of an application interface displaying an operating system home screen, according to an exemplary embodiment.

FIG. 4 is a schematic diagram of an application interface displaying an operating system home screen, according to an exemplary embodiment.

FIG. 5 is a block diagram of an apparatus for controlling display of an application interface, according to an exemplary embodiment.

FIG. 6 is a block diagram of a terminal device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

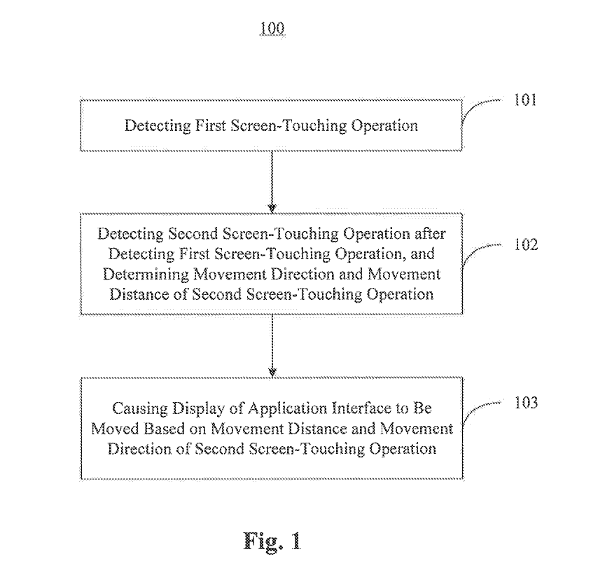

FIG. 1 is a flowchart of a method 100 for controlling display of an application interface, according to an exemplary embodiment. The method 100 may be performed by a terminal device, and the application interface may include two or more pages for displaying on the terminal device. Referring to FIG. 1, the method 100 includes the following steps.

In step 101, the terminal device detects a first screen-touching operation.

In this disclosure, the screen-touching operation refers to an operation triggered by a user on a touch-screen display of the terminal device, and each screen-touching operation may trigger a corresponding operation of the terminal device. For example, a tapping operation on an application icon may trigger an application corresponding to the application icon to be started. Also for example, a correspondence between the screen-touching operation and the corresponding operation of the terminal device may be preset by technical personnel or may be set by the user.

The first screen-touching operation is not intended to be limited. For example, the first screen-touching operation may be a press and hold operation, a sliding operation, or the like. For example, the first screen-touching operation may be a sliding operation with a certain sliding distance.

In some embodiments, after detecting that a screen-touching operation is performed, the terminal device may determine the screen-touching operation as the first screen-touching operation.

In step 102, the terminal device detects a second screen-touching operation after detecting the first screen-touching operation, and determines a movement direction and a movement distance of the second screen-touching operation.

The movement direction of the second screen-touching operation may be a horizontal direction or a vertical direction. For example, the second screen-touching operation may be a rightward sliding or a downward sliding operation configured to trigger a next page of the application interface to be displayed. The corresponding movement of the application interface display triggered by the movement direction of the second screen-touching operation is not intended to be limited by the embodiments of the present disclosure.

The movement distance refers to a distance between a start-point and an end-point of the second screen-touching operation. The start-point and the end-point may each be denoted by coordinates. In this disclosure, the end-point refers to a touch point of the second screen-touching operation on a moving path when the second screen-touching operation is completed.

In step 102, when the second screen-touching operation is detected, the terminal device may determine the movement direction and the movement distance of the second screen-touching operation and may also enter into a free movement mode.

In some embodiments, step 102 may include sub-steps 102a and 102b for determining the movement direction of the second screen-touching operation.

In sub-step 102a, if an angle between a horizontal direction and a direction formed by the start-point coordinates and the end-point coordinates of the second screen-touching operation is less than or equal to a preset angle, the terminal device may determine that the movement direction of the second screen-touching operation is the horizontal direction.

The preset angle may be set by developer, or may be set by the user in a personalized manner. In some embodiments, the preset angle is set to 45 degrees.

In the method 100, the screen-touching operation may be a substantially horizontal sliding or a substantially vertical sliding. In some implementations, an angle may be present between the direction of the screen-touching operation and the horizontal direction. For example, when the angle between the horizontal direction and the direction formed by the start-point coordinates and the end-point coordinates of the second screen-touching operation is less than or equal to the preset angle, the horizontal direction may be determined as the movement direction of the second screen-touching operation. For example, the horizontal direction may be a leftward direction or a rightward direction.

In sub-step 102b, if the angle between the horizontal direction and the direction formed by the start-point coordinates and the end-point coordinates of the second screen-touching operation is greater than the preset angle, the terminal device may determine that the movement direction of the second screen-touching operation is a vertical direction. For example, the vertical direction may be an upward direction or a downward direction.

For example, if the angle between the horizontal direction and the direction formed by the start-point coordinates and the end-point coordinates of the second screen-touching operation is 30 degrees, it may be determined that the movement direction of the second screen-touching operation is the horizontal direction. If the angle between the horizontal direction and the direction formed by the start-point coordinates and the end-point coordinates of the second screen-touching operation is 60 degrees, it may be determined that the movement direction of the second screen-touching operation is the vertical direction.

In other embodiments, instead of the implementations described in the above sub-steps 102a and 102b, the movement of the application interface may also be controlled according to the actual movement direction of the second screen-touching operation.

In some embodiments, step 102 may include the following sub-step 102c or sub-step 102d for determining the movement distance of the second screen-touching operation.

In sub-step 102c, based on the start-point coordinates and the end-point coordinates of the second screen-touching operation, the terminal device may acquire a straight line distance between the start-point and the end-point, and determine the movement distance of the second screen-touching operation to be the straight line distance.

In sub-step 102d, according to a preset number of points between the start-point coordinates and the end-point coordinates of the second screen-touching operation, the terminal device may acquire a curve length between the start-point coordinates and the end-point coordinates, and determine the movement distance of the second screen-touching operation to be the curve length.

In this sub-step, a preset number of points between the start-point coordinates and the end-point coordinates of the second screen-touching operation are selected. A straight line distance between every two adjacent points is acquired, and the acquired straight line distances between every two adjacent points are summed together. The calculated total distance is acquired as the curve length between the start-point coordinates and the end-point coordinates, and the curve length is determined as the movement distance of the second screen-touching operation.

It should be noted that, whether the moving path of the second screen-touching operation is a straight line or a curve, any of the above methods may be applied so as to acquire the movement distance. In exemplary embodiments, to determine the movement distance, the type of the moving path may be determined first. For example, the terminal device may determine whether the moving path of the second screen-touching operation is a straight line or a curve. When it is detected that the moving path of the second screen-touching operation is a straight line, the terminal device may calculate the straight line distance between the start-point coordinates and the end-point coordinates of the second screen-touching operation, and determine the movement distance of the second screen-touching operation to be the straight line distance. When it is detected that the moving path of the second screen-touching operation is a curve, the terminal device may select a preset number of points between the start-point coordinates and the end-point coordinates of the second screen-touching operation, and acquire a straight line distance between every two adjacent points. The terminal device may further sum the acquired straight line distances between every two adjacent points, obtain a total distance as the curve length between the start-point coordinates and the end-point coordinates, and determine the movement distance of the second screen-touching operation to be the curve length.

In some implementations, the preset number of points may be set by the developer, or may be set by the user. In exemplary embodiments, to improve the accuracy of the acquired curve length, the preset number may be set as a relatively large number.

In the method 100, depending on different application interfaces, the first screen-touching operation and the second screen-touching operation may be a vertically straight sliding or a horizontally straight sliding operation. The movement direction of the first screen-touching operation and that of the second screen-touching operation may be parallel to each other or perpendicular to each other. For example, both the first screen-touching operation and the second screen-touching operation may be horizontally straight sliding operations or vertically straight sliding operations. As another example, the first screen-touching operation may be a horizontally straight sliding operation, and the second screen-touching operation may be a vertically straight sliding operation. As another example, the first screen-touching operation may be a vertically straight sliding operation and the second screen-touching operation may be a horizontally straight sliding operation.

In step 103, the terminal device causes the display of the application interface to be moved based on the movement direction and the movement distance of the second screen-touching operation. In some embodiments, the display of the application interface may be moved along the movement direction of the second screen-touching operation over a distance equal to the movement distance of the second screen-touching operation.

For example, the application interface may be generated according to data stored in a database of the terminal device. The data in the database of the terminal device may include contents to be displayed on the touch-screen display and associated displaying positions of the contents. For example, for a certain user interface page, displayed contents may include A-F icons, and the displaying positions of the icons may be sequentially arranged. The application interface may contain a plurality of user interface pages, and contents of the application interface may be displayed on the touch-screen display page by page (in a pagination manner) according to the size of the touch-screen display, thereby allowing the user to perform a browse operation.

In step 103, when the user triggers the second screen-touching operation after the first screen-touching operation, the terminal device acquires the movement direction and the movement distance of the second screen-touching operation, and causes the display of the application interface to be moved according to the movement direction and movement distance of the second screen-touching operation. For example, the display of the application interface may be moved along the movement direction of the second screen-touching operation over the distance equal to the movement distance of the second screen-touching operation. In one embodiment, once the second screen-touching operation is completed, the contents of the application interface may be positioned at a position of the display where the contents are positioned at the end of the second screen-touching operation. The contents being displayed may include partial contents of two adjacent pages. Different from the pagination displaying according to a screen-touching operation, the application interface display may be moved arbitrarily in this embodiment, such that the user may move the application interface display beyond a boundary of a page during the usage, thereby facilitating a fast browse.

The method 100 may be applied to a scenario in which the terminal device includes an application interface with two or more user interface pages to be displayed on the terminal device. In exemplary embodiments, the application interface includes but is not limited to an application program interface and an operating system interface. For example, the application program interface may be an interface of an E-book or an interface of an E-album to be browsed by turning pages. The operating system interface may be an operating system home screen, a system setting interface, an application management interface, and the like.

In the method 100, the triggered interface operation when the second screen-touching operation is detected before the completion of the first screen-touching operation includes initiation of the free movement mode of the interface, in which the application interface is processed according to the second screen-touching operation. Further, the first screen-touching operation may not be limited to a particular screen-touching operation. For example, the first screen-touching operation may be a press and hold operation or a sliding operation to the application interface. In some embodiments, the second screen-touching operation may be a sliding operation to any direction.

In the method 100, the display of the interface is controlled to move according to the movement direction and the movement distance of the second screen-touching operation detected before the completion of the first screen-touching operation, thereby enabling display of the application interface to move freely across pages for the convenience of user browse

In some embodiments, after causing the display of the application interface to be moved in step 103, e.g., along the movement direction of the second screen-touching operation over the distance equal to the movement distance of the second screen-touching operation, the method 100 may further include a first additional step.

In the first additional step, when it is detected that the second screen-touching operation is completed, the terminal device may cause the contents of the application interface to be positioned at a position of the display where the contents of the application interface are positioned at the end of the second screen-touching operation.

In some implementations, the second screen-touching operation is determined to be completed when the touch point of the second screen-touching operation leaves the touch-screen display. For example, when it is detected that the second screen-touching operation is completed, the contents of the application interface may be positioned at the position where the contents of the application interface are positioned at the end of the second screen-touching operation and be maintained thereto.

In the present embodiment, the application interface may include a plurality of user interface pages, and each page may display a plurality of application icons. For example, the first screen-touching operation may be a horizontally straight sliding operation and the second screen-touching operation may be a vertically straight sliding operation. Once a vertically straight sliding operation is detected during the process of detecting a horizontally straight sliding operation, the currently displayed page, e.g., the first page of the application interface, may be controlled to move along the movement direction of the vertically straight sliding operation over a distance equal to the movement distance of the vertically straight sliding operation. With the movement of the pages, the contents displayed on the application interface may change continuously. For example, the displayed contents may change from all of the application icons of the first page into a group of the icons of the first page and a group of the icons of a second page adjacent to the first page. Once the vertically straight sliding operation is finished, the current displayed contents may remain unchanged, and be positioned at a location where the contents are located at the end of the vertically straight sliding operation. As a result, the displayed contents may include a group of the icons of the first page and a group of the icons of the second page adjacent to the first page.

In some embodiments, after the first additional step of positioning contents of the application interface at the location where the second screen-touching operation is finished, the method 100 may further include a second additional step.

In the second additional step, the terminal device detects a third screen-touching operation for triggering a pagination movement of the application interface causes the application interface display to be moved along a movement direction of the third screen touching operation, and causes entire contents of a user interface page to be displayed. For example, the user interface page displayed may be the first full page to be displayed when the application interface display is moved along the movement direction of the third screen-touching operation.

For example, the third screen-touching operation may be a sliding operation, and may trigger an interface operation of turning pages.

In some implementations, when a full page of the application interface is displayed after the first additional step is performed, the display of the application interface may be moved according to the third screen-touching operation.

In some implementations, when the contents of the application interface are positioned at a location where the contents are positioned at the end of the second screen-touching operation, and a full page of the application interface is displayed when the second screen-touching operation is finished, the display of the application interface may be moved according to an interface operation triggered by the third screen-touching operation. In the present disclosure, the displayed contents of a full page include the entire contents of the page stored in the database of the terminal device that are to be displayed.

For example, if the displayed contents of the application interface after the positioning are the contents of page 2, and the detected third screen-touching operation is a rightward sliding, the application interface may be controlled to display the contents of page

In some embodiments, when the displayed contents of the application interface after the second screen-touching operation include a part of the contents of a user interface page in the application interface and a part of the contents of an adjacent page, the display of application interface may be moved according to the third screen-touching operation, and the first full page to be displayed along the movement direction of the third screen-touching operation may be displayed in its entirety.

Contents of the application interface may be displayed in a pagination manner of a plurality of user interface pages. The page adjacent to a particular page may be referred to as an adjacent page to the particular page, for example, a previous page or a next page of the particular page.

In some embodiments, if contents of the application interface are positioned at a location where the second screen-touching operation is finished, and the displayed contents in the application interface when the second screen-touching operation is finished include a part of the contents of a page of the application interface and a part of the contents of an adjacent page, when the third screen-touching operation is detected, the display of the application interface may be moved according to an interface operation triggered by the third screen-touching operation, and entire contents of a user interface page may be displayed when the third screen-touching operation is completed. For example, the first full page to be displayed toward the movement direction of the third screen-touching operation may be displayed in its entirety, When the second screen-touching operation is finished, the display of the application interface may exit from the free movement mode. Thus, once the third screen-touching operation is detected, the current display of the application interface may be processed according to the interface operation triggered by the third screen-touching operation. That is, when the third screen-touching operation is detected, the application interface may be displayed page by page according to the third screen-touching operation. When the third screen-touching operation is finished, the application interface may display a full page of the page at which the application interface is located when the operation is finished.

For example, if the displayed contents of the application interface after the second screen-touching operation include a part of the contents of a second page and a part of the contents of a third page, and the acquired third screen-touching operation is a rightward sliding, the application interface may be controlled to display the entire contents of the third page. If the user performs a rightward sliding operation once more, the application interface displays the contents of a fourth page. On the other hand, if the user performs a leftward sliding operation, the application interface displays the contents of the second page.

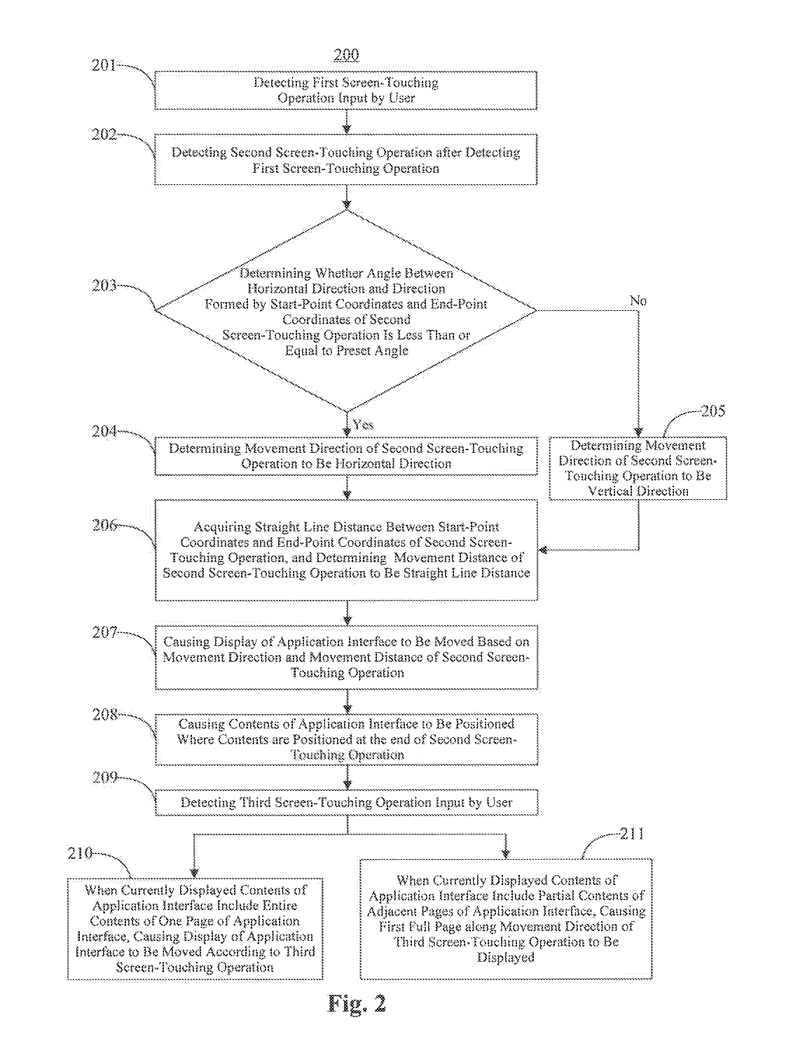

FIG. 2 is a flowchart of a method 200 for controlling display of an application interface, according to an exemplary embodiment. The method 200 may be performed h a terminal device, and the application interface includes two or more user interface pages for displaying on the terminal device. Referring to FIG. 2, the method 200 includes the following steps.

In step 201, the terminal device detects a first screen-touching operation input by a user.

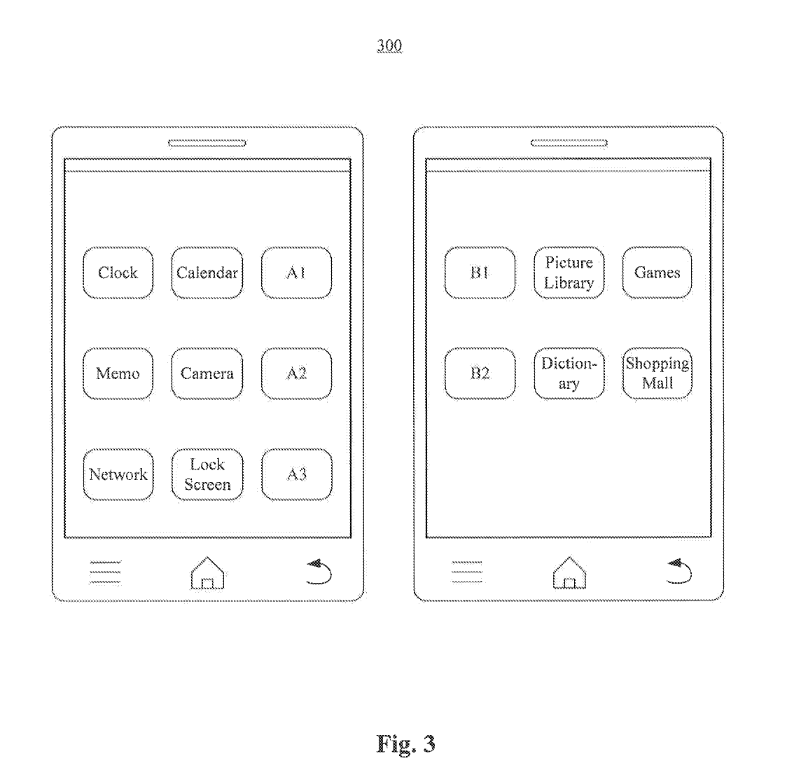

In the following description of the method 200, a home screen for a mobile operating system is used as an example. FIG. 3 is a schematic diagram of an application interface 300 displaying a first page and a second page of a home screen for a mobile operating system, according to an exemplary embodiment. As shown in FIG. 3, the first page of the home screen includes 9 application icons, which are clock, memo, network, calendar, camera, lock screen, A1, A2, and A3, respectively. The second page of the home screen includes 6 application icons, which are B1, B2, picture library, dictionary, games, and shopping mall, respectively.

In step 202, the terminal device detects a second screen-touching operation after detecting the first screen-touching operation.

When the second screen-touching operation is detected during the process of detecting the first screen-touching operation, the application interface enters into a free movement mode, and partial contents of multiple pages of the application interface may be displayed.

In step 203, the terminal device determines whether an angle between a horizontal direction and a direction formed by start-point coordinates and end-point coordinates of the second screen-touching operation is less than or equal to a preset angle, e.g., 45 degrees. If the angle is less than or equal to the preset angle, step 204 is performed. Otherwise, step 205 is performed.

In step 204, the terminal device determines the movement direction of the second screen-touching operation to be the horizontal direction, and proceeds to step 206.

In step 205, the terminal device determines the movement direction of the second screen-touching operation to be the vertical direction, and proceeds to step 206.

In step 206, the terminal device acquires a straight line distance between the start-point coordinates and the endpoint coordinates of the second screen-touching operation, and determines the movement distance of the second screen-touching operation to be the straight line distance

In step 207, the terminal device causes display of the application interface to be moved based on the movement direction and the movement distance of the second screen-touching operation, e.g., along the movement direction of the second screen-touching operation over a distance equal to the movement distance of the second screen-touching operation.

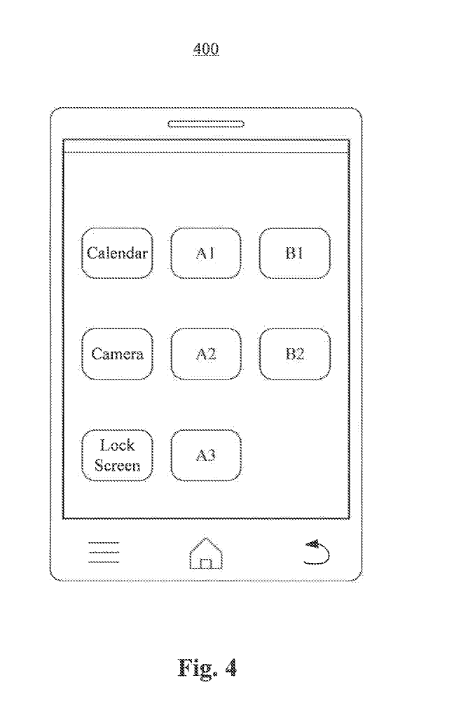

During the action of the second screen-touching operation, displayed contents of the application interface may continuously change. FIG. 4 is a schematic diagram of an application interface 400 displaying a home screen of a mobile operating system, according to an exemplary embodiment. As shown in FIG. 4, the currently displayed application interface during the action of the second screen-touching operation includes partial contents of the first page and partial contents of the second page of the application interface. Specifically, the displayed application icons include calendar, camera, lock screen, A1, A2, and A3 of the first page, and B1 and B2 of the second page.

In step 208, when it is detected that the second screen-touching operation is completed, the terminal device causes contents of the application interface to be displayed at a location where the contents of the application interface are positioned at the end of the second screen-touching operation.

When it is detected that the second screen-touching operation is completed, the display of the application interface may exit from the free movement mode, and be maintained at the same position where the second screen-touching operation is finished.

For example, in connection with step 207 and FIG. 4 discussed above, when it is detected that the second screen-touching operation is finished, the displayed contents of the application interface shown in FIG. 4 may remain unchanged and be maintained. As shown in FIG. 4, the displayed application icons after the completion of the second screen-touching operation include calendar, camera, lock screen, A1, A2, and A3 of the first page, and B1 and B2 of the second page.

Through the free movement mode which allows display of the application interface to move beyond a page boundary, partial contents of multiple pages may be displayed concurrently. For example, partial contents of the adjacent pages may be displayed in the same displaying interface, thereby improving the ease of user browse.

In step 209, the terminal device detects a third screen-touching operation input by the user.

In step 210, when the currently displayed contents of the application interface include entire contents of one user interface page of the application interface, the terminal device causes display of the application interface to be moved according to the third screen-touching operation.

In step 211, when the currently displayed contents of the application interface include partial contents of a page of the application interface and partial contents of an adjacent page, the terminal device causes display of the application interface to be moved according to the third screen-touching operation, identify the first page of the application interface that is to be displayed toward the movement direction of the third screen-touching operation, and causes the entire contents of the first page to be displayed.

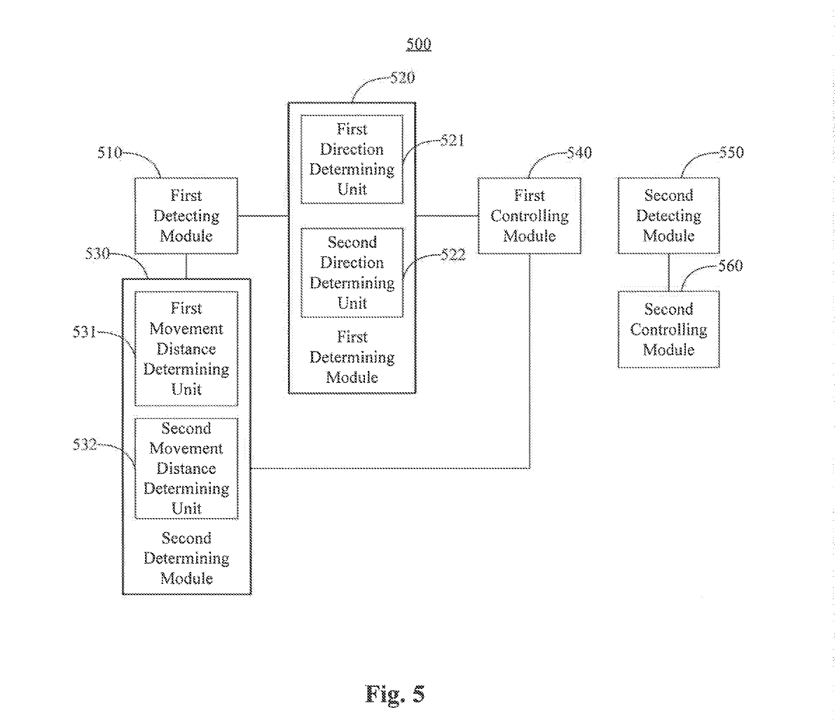

FIG. 5 is a block diagram of an apparatus 500 for controlling display of an application interface, according to an exemplary embodiment. Referring to FIG. 5, the apparatus 500 includes a first detecting module 510, a first determining module 520, a second determining module 530, and a first controlling module 540.

The first detecting module 510 is configured to detect a first screen-touching operation, and detect a second screen-touching operation after detecting the first screen-touching operation.

The first determining module 520 is configured to determine a movement direction of the second screen-touching operation.

The second determining module 530 is configured to determine a movement distance of the second screen-touching operation.

The first controlling module 540 is configured to cause display of the application interface to be moved based on the movement direction and movement distance of the second screen-touching operation, e.g., along the movement direction of the second screen-touching operation over a distance equal to the movement distance of the second screen-touching operation.

In some embodiments, the first determining module 520 includes a first direction-determining unit 521 and a second direction-determining unit 522.

The first direction-determining unit 521 is configured to determine the movement direction of the second screen-touching operation to be the horizontal direction, if an angle between a horizontal direction and a direction formed by start-point coordinates and end-point coordinates of the second screen-touching operation is less than or equal to a preset

The second direction-determining unit 522 is configured to determine the movement direction of the second screen-touching operation to be a vertical direction, if the angle between the horizontal direction and the direction formed by the start-point coordinates and the end-point coordinates of the second screen-touching operation is greater than the preset angle.

In some embodiments, the second determining module 530 includes a first movement distance determining unit 531 and/or a second movement distance determining unit 532.

The first movement distance determining unit 531 is configured to acquire a straight line distance between the start-point coordinates and the end-point coordinates of the second screen-touching operation, and determine the movement distance of the second screen-touching operation to be the straight line distance.

The second movement distance determining unit 532 is configured to, acquire a curve length between the start-point coordinates and the end-point coordinates based on a preset number of points between the start-point coordinates and the end-point coordinates of the second screen-touching operation, and determine the movement distance of the second screen-touching operation to be the curve length.

In some embodiments, the first controlling module 540 is further configured to, when the first detecting module 510 detects that the second screen-touching operation is completed, maintain the display of the application interface at a location where the second screen-touching operation is finished.

In some embodiments, the apparatus further 500 includes a second detecting module 550 and a second controlling module 560.

The second detecting module 550 is configured to detect a third screen-touching operation for triggering a pagination movement of the application interface display.

The second controlling module 560 is configured to control the application interface to display a first full page along a movement direction of the third screen-touching operation.

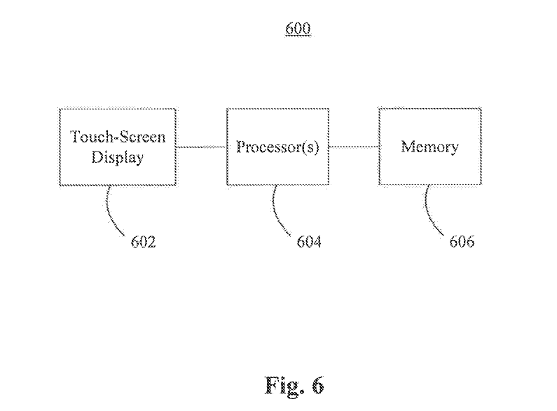

FIG. 6 is a block diagram of a terminal device 600, according to an exemplary embodiment. Referring to FIG. 6, the terminal device 600 includes a touch-screen display 602, one or more processors 604, and a memory 606 configured to store programs and modules executable by the one or more processors 604. The one or more processors 604 may be configured to perform various functions and data processing by operating programs and modules stored in the memory 606. For example, the one or more processors 604 may be configured to execute instructions so as to perform all or a part of the steps in the above described methods.

In exemplary embodiments, there is further provided a non-transitory computer-readable storage medium including instructions, such as included in the memory 606, executable by the one or more processors 604 in the terminal device 600, to perform the above-described methods. For example, the non-transitory computer-readable storage medium may be a read-only memory (ROM), a random access memory (RAM), a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It should be understood that the present disclosure is not limited to the exact construction that has been described above and illustrated in the accompanying drawings, and that various modifications and changes can be made without departing from the scope thereof it is intended that the scope of the invention only be limited by the appended claims.

What is claimed is:

1. A method for controlling display of an application interface, comprising:
detecting a first screen-touching operation;
detecting a second screen-touching operation after detecting the first screen-touching operation;
determining a movement direction and a movement distance of the second screen-touching operation; and
causing the display of the application interface to be moved based on the movement direction and the movement distance of the second screen-touching operation.

2. The method according to claim 1, wherein the display of the application interface is moved along the movement direction of the second screen-touching operation over a distance equal to the movement distance of the second screen-touching operation.

3. The method according to claim 1, wherein the application interface includes two or more user interface pages for displaying on a terminal device.

4. The method according to claim 1, wherein determining the movement direction of the second screen-touching operation comprises:
if an angle between a horizontal direction and a direction formed by start-point coordinates and end-point coordinates of the second screen-touching operation is less than or equal to a preset angle, determining the movement direction of the second screen-touching operation to be the horizontal direction; and
if the angle between the horizontal direction and the direction formed by the start-point coordinates and the end-point coordinates of the second screen-touching operation is greater than the preset angle, determining the movement direction of the second screen-touching operation to be a vertical direction.

5. The method according to claim 1, wherein determining the movement distance of the second screen-touching operation comprises:
acquiring a straight line distance between start-point coordinates and end-point coordinates of the second screen-touching operation; and
determining the movement distance of the second screen-touching operation to be the straight line distance.

6. The method according to claim 1, wherein determining the movement distance of the second screen-touching operation comprises:
acquiring a curve length between start-point coordinates and end-point coordinates of the second screen-touching operation based on a preset number of points between the start-point coordinates and the end-point coordinates; and
determining the movement distance of the second screen-touching operation to be the curve length.

7. The method according to claim 1, further comprising:
after detecting that the second screen-touching operation is completed, positioning contents of the application interface at a position in a display where the contents of the application interface are positioned at the end of the second screen-touching operation.

8. The method according to claim 7, further comprising:
detecting a third screen-touching operation for triggering a pagination movement of the display of the application interface; and
causing the display of the application interface to be moved along a movement direction of the third screen-touching operation and causing entire contents of a user interface page of the application interface to be displayed.

9. A terminal device, comprising:
a touch-screen display;
a processor; and
a memory for storing instructions executable by the processor;
wherein the processor is configured to:
detect a first screen-touching operation;
detect a second screen-touching operation after detecting the first screen-touching operation;
determine a movement direction and a movement distance of the second screen-touching operation; and
cause the display of the application interface to be moved based on the movement direction and the movement distance of the second screen-touching operation.

10. The terminal device according to claim 9, wherein the display of the application interface is moved along the movement direction of the second screen-touching operation over a distance equal to the movement distance of the second screen-touching operation.

11. The terminal device according to claim 9, wherein the application interface includes two or more user interface pages for displaying on the touch-screen display.

12. The terminal device according to claim 9, wherein when determining the movement direction of the second screen-touching operation, the processor is configured to:
if an angle between a horizontal direction and a direction formed by start-point coordinates and end-point coordinates of the second screen-touching operation is less than or equal to a preset angle, determine the movement direction of the second screen-touching operation to be the horizontal direction; and
if the angle between the horizontal direction and the direction formed by the start-point coordinates and the end-point coordinates of the second screen-touching operation is greater than the preset angle, determine the movement direction of the second screen-touching operation to be a vertical direction.

13. The terminal device according to claim 9, wherein when determining the movement distance of the second screen-touching operation, the processor is configured to:
acquire a straight line distance between start-point coordinates and end-point coordinates of the second screen-touching operation; and
determine the movement distance of the second screen-touching operation to be the straight line distance.

14. The terminal device according to claim 9, wherein when determining the movement distance of the second screen-touching operation, the processor is configured to:
acquire a curve length between start-point coordinates and end-point coordinates of the second screen-touching operation based on a preset number of points between the start-point coordinates and the end-point coordinates; and
determine the movement distance of the second screen-touching operation to be the curve length.

15. The terminal device according to claim 9, wherein the processor is further configured to after detecting that the second screen-touching operation is completed, positioning contents of the application interface at a position in the touch-screen display where the contents of the application interface are positioned at the end of the second screen-touching operation.

16. The terminal device according to claim 15, wherein the processor is further configured to:
detect a third screen-touching operation for triggering a pagination movement of the display of the application interface; and
cause the display of the application interface to be moved along a movement direction of the third screen-touching operation and cause entire contents of a user interface page of the application interface to be displayed.

17. A non-transitory computer readable storage medium having stored therein instructions that, when executed by a processor of a terminal device, cause the terminal device to perform a method for controlling display of an application interface, the method comprising:
detecting a first screen-touching operation;
detecting a second screen-touching operation after detecting the first screen-touching operation;
determining a movement direction and a movement distance of the second screen-touching operation; and
causing the display of the application interface to be moved based on the movement direction and the movement distance of the second screen-touching operation.
